(19) United States
(12) Patent Application Publication
(10) Pub. No.: US 2016/0366952 A1
(43) Pub. Date: Dec. 22, 2016

(54) BIOMECHANICAL ENERGY AIRED PROTECTIVE APPAREL

(71) Applicant: William J. Plut, Los Altos, CA (US)

(72) Inventor: William J. Plut, Los Altos, CA (US)

(73) Assignee: HONEYWOOD TECHNOLOGIES, LLC, Los Altos, CA (US)

(21) Appl. No.: 14/744,899

(22) Filed: Jun. 19, 2015

(51) Int. Cl. A41D 13/002; A62B 17/00

(52) U.S. Cl. CPC A41D 13/002; A62B 17/006

(57) ABSTRACT

Described herein is protective apparel intended for use against an undesirable liquid agent. The apparel permits low pressure air movement between the environment external to the apparel and an internal volume within the apparel. Compliant spacers maintain an internal volume between a wearer and an outer shroud material in the apparel. One or more holes in the apparel permit air movement between the internal volume and external environment. The low pressure air movement permits biomechanical energy of the wearer to move air in and out of the apparel.

### FIELD OF THE INVENTION

The present invention relates to protective apparel. In particular, the invention relates to protective apparel that enables biomechanical energy to move air and out of the apparel.

### BACKGROUND

Protective apparel is used in many environments that offer an undesirable agent. Recent worldwide outbreaks of severe acute respiratory syndrome (SARS) and Ebola have required health care practitioners to interact with patients that are knowingly afflicted. Practitioners in infectious disease and medical environments such as these are prone to contamination from liquid-borne and droplet-transmitted biological agents. Industrial and chemical environments also offer a variety of liquid and solid threats. Protective apparel is also used in applications such as clean rooms and surgical rooms to maintain a sterile zone and prevent passage of liquid contaminants from a person wearing the apparel to the sterile zone or patient.

Thermal discomfort is a repeated complaint for conventional protective apparel. If a user walks considerably, or performs other physical tasks such as lifting sick patients, most conventional surgical suits cannot manage the extra heat, which raises discomfort. Some applications require protective apparel to be worn for prolonged periods, which can amplify any thermal discomfort.

Africa's ongoing Ebola outbreaks spread to rural areas where electrical infrastructure was not readily or reliably available. In these conditions, protective apparel that relies on fans to move air through a suit become less feasible since the battery recharging becomes uncertain.

Based on the foregoing, it should be apparent that new protective apparel is desirable.

### OVERVIEW

Protective apparel described herein is intended for use against an undesirable liquid agent. The apparel permits low pressure air movement between the environment external to the apparel and an internal volume within the apparel. Spacers maintain an internal volume between a wearer and an outer shroud material in the apparel. One or more holes in the apparel permit the air movement between the internal volume and the external environment. The low pressure air movement permits biomechanical energy of the wearer to move air in and out of the apparel.

In some embodiments, the present invention relates to apparel for protecting a person from an undesirable liquid agent. The apparel includes a liquid resistant shroud material employed in a body portion that covers: at least a portion of a torso of the person when the person wears the apparel, a first sleeve configured to receive a portion of a right arm of the person, and a second sleeve configured to receive a portion of a left arm of the person. The apparel also includes a set of internal spacers. Each spacer maintains shroud material proximate to the spacer distant from the person. The set of spacers creates and maintain an internal volume between the liquid resistant shroud material and a person wearing the apparel. The apparel further includes at least one hole in the liquid resistant shroud material that includes a surface area of at least about 70 square centimeters and is configured to permit air movement between the internal volume and an external environment.

In other embodiments, the present invention relates to a method of protecting a person from an undesirable liquid agent. The method includes providing a liquid resistant shroud material including a body portion configured to cover: at least a portion of a torso of the person when the person wears the apparel, a first sleeve configured to receive a portion of a right arm of the person, and a second sleeve configured to receive a portion of a left arm of the person. The method also includes providing a set of spacers configured to maintain an internal volume between the liquid resistant shroud material and a person wearing the apparel. The method further includes maintaining at least one hole in the liquid resistant shroud material. The at least one hole includes a surface area of at least about 70 square centimeters and is configured to permit air movement between the internal volume and an external environment. The method also includes obstructing the undesirable liquid agent from entering the at least one hole from the external environment.

In yet other embodiments, the present invention relates to a method of using protective apparel worn by a person. The method includes donning an undergarment including a set of spacers. The method also includes donning a liquid resistant shroud material including a) a body portion configured to cover at least a portion of a torso of the person when the person wears the apparel, b) a first sleeve configured to receive a portion of a right arm of the person, and c) a second sleeve configured to receive a portion of a left arm of the person, and d) at least one hole that is configured to permit air movement between the internal volume and the external environment outside the outer garment. The set of spacers is configured to maintain an internal volume when the person wears the apparel. The method further includes using biomechanical energy of the person wearing the apparel to move air through the at least one hole and between the internal volume and the external environment.

These and other features of the present invention will be presented in more detail in the following detailed description of the invention and the associated figures.

### BRIEF DESCRIPTION OF THE DRAWINGS

FIG. 1 illustrates an outer front elevation view of protective apparel in accordance with one embodiment.

FIG. 2A illustrates a horizontal cross section of the person and apparel of FIG. 1 taken through a chest region of the person in accordance with one embodiment.

FIG. 2B illustrates a horizontal cross section of the person and apparel of FIG. 1 taken through an abdominal region of the person in accordance with one embodiment.

FIG. 2C illustrates a front view of spacers attached to an undergarment and positioned about the chest and shoulders of a person in accordance with another specific embodiment.

FIG. 3 illustrates a top perspective view of a compliant spacer suitable for use in the apparel of FIG. 1 in accordance with another embodiment.

FIG. 4A illustrates a side elevation view of a headgear assembly disposed within the hood of the apparel shown in FIG. 1 in accordance with a specific embodiment.

FIG. 4B illustrates a top view of the headgear assembly of FIG. 4A.

FIG. 5A shows an elevated perspective view of an airway tube (separated from the apparel of FIG. 1) in accordance with a specific embodiment.

FIG. 5B shows a liquid obstruction for use in the tube of FIG. 5A in accordance with a specific embodiment.

FIG. 5C shows another liquid obstruction placed in in an airway tube in accordance with another specific embodiment.

FIG. 6 illustrates a method for protecting a person from an undesirable liquid agent in accordance with one embodiment.

FIG. 7 illustrates a method for using protective apparel in accordance with another embodiment.

### DETAILED DESCRIPTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Protective apparel described herein enables protection from an undesirable liquid agent and permits low pressure air movement between an environment external to the apparel and an internal volume within the apparel.

To assist in the low pressure air movement, the protective apparel includes a set of spacers to establish and maintain the internal volume. Each spacer maintains the shroud material proximate to it distant from the person, thereby preventing continuous contact between the person and portions of the shroud material near the spacer. Collectively, multiple spacers form air channels between the spacers, the person, and inner portions of the shroud material. The channels permit low resistance and low pressure airflow within the shroud material and within the internal volume of the apparel. Low resistance airflow within the channels permits air to be easily moved underneath the shroud material. The air cools the person. The air also permits low pressure air communication to a hole in the apparel that leads to the external environment, thus readily transferring air into and out of large portions of the apparel via the hole.

The person's biomechanical energy and movements change the internal air pressure within the apparel, and are enough to move the air: a) within the apparel via the low resistance airflow channels, and b) into and out of the apparel via the hole. The biomechanical energy derives from movements the person makes while wearing the apparel.

The apparel may also include one or more liquid obstructions to reduce fluid movement into the apparel. In one specific embodiment, a liquid obstruction is disposed to disturb or impede a liquid attempting to move through the hole used for low pressure airflow in and out of the suit. In another specific embodiment, the apparel includes an airway tube that extends from the hole and the liquid obstruction is held in the airway tube.

Combining the biomechanical energy and low pressure airflow results in apparel that does not need a fan or electrical power to move air in and out while a person wears the apparel.

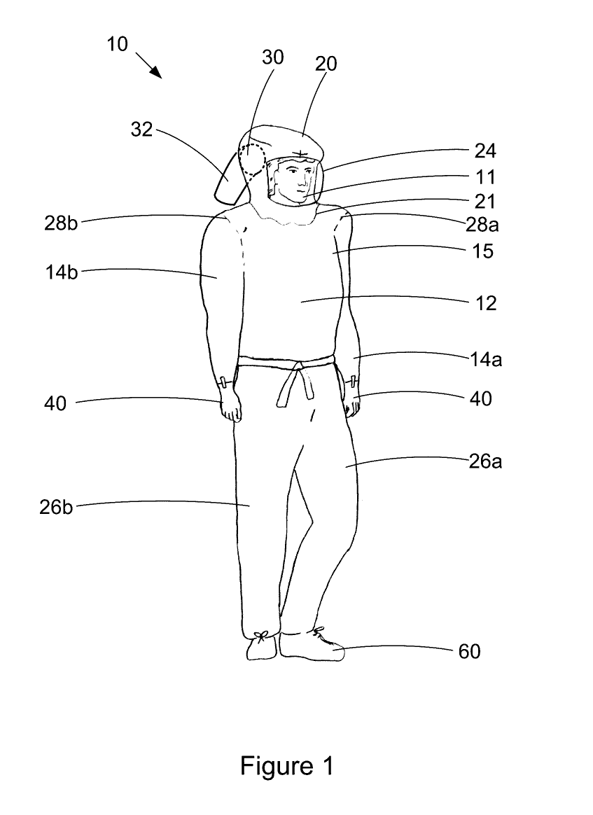

FIG. 1 illustrates an outer front elevation view of protective apparel 10 in accordance with one embodiment of the present invention. While the present invention will now be described as protective apparel useful for protecting a person from an undesirable liquid agent, improving comfort and thermal management for its wearer, and/or improving airflow internal to the apparel, those skilled in the art will recognize that the subsequent description may also illustrate methods and discrete actions for improving thermal management and improving airflow internal to apparel.

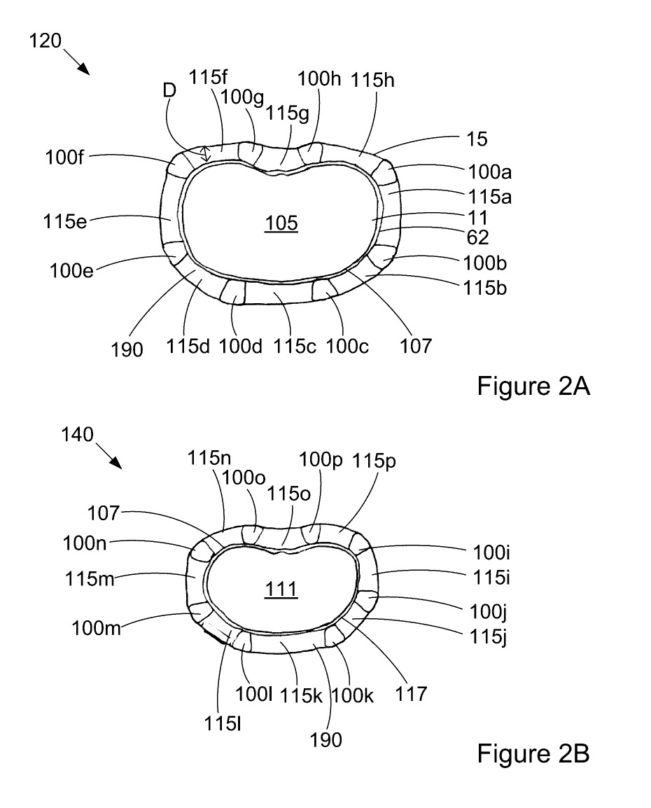

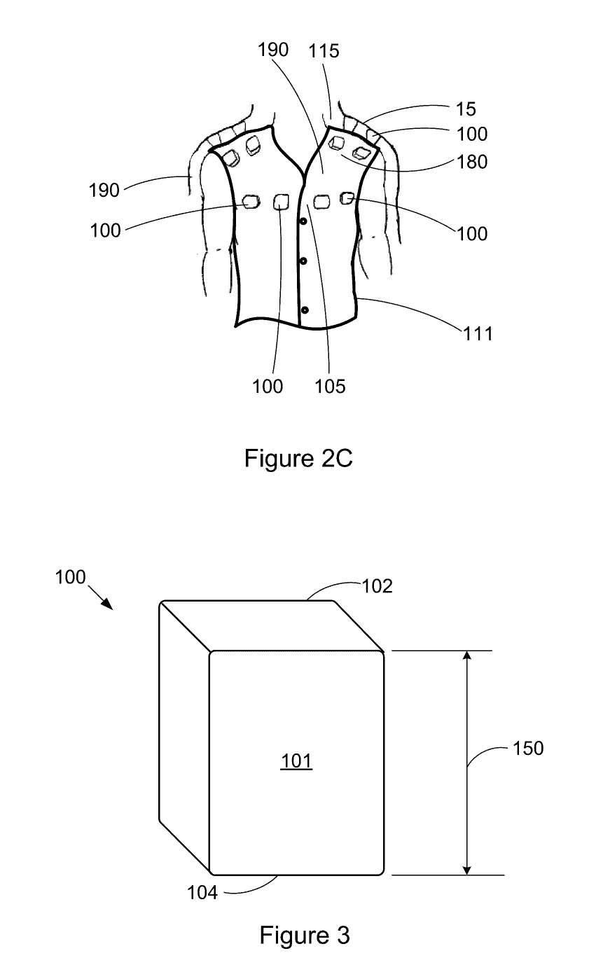

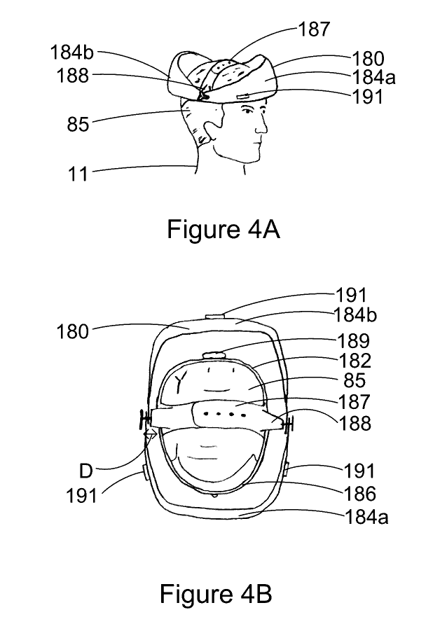

Apparel 10 generally refers to a garment assembly for use by a person 11. Apparel 10 comprises multiple components that are attached to form the garment assembly. As shown in FIG. 1, apparel 10 includes body portion 12, sleeves 14, hood 20, pant legs 26, hole 30, tube 32, and boots 60. Apparel 10 also comprises a separate headgear assembly (FIGS. 4A and 4B) worn underneath hood 20, and spacers (FIGS. 2A-3) disposed between shroud material 15 and person 11. In one embodiment, apparel 10 resembles a garment assembly or full-body suit that covers most of person 12. In this case, apparel 10 creates an environment internal to apparel 10 and separates the internal environment from an environment external to apparel 10, except via gaseous communication between the two via hole 30. In another embodiment, apparel 10 resembles a gown with an open bottom and no pant legs 26. The open gown may extend to the person's waist, ankles, or any height therebetween, and uses a belt or ties (e.g., at the waist) to secure the shroud material 15 and establish an internal environment above the belt or ties.

Shroud material 15 provides a physical barrier between the environment internal to apparel 10 and the environment external to apparel 10. Shroud material 15 comprises a relatively thin, flaccid or semi-flaccid sheet. Shroud material 15 is included in most components of apparel 10, such as body portion 12, sleeves 14, pant legs 26, optionally boots 60, and hood 20. In one embodiment, apparel 10 is designed to loosely fit about person 11. In this case, shroud material 15 loosely fits about person 11.

In a specific embodiment, apparel 10 employs a liquid resistant or liquid impervious material 15 that complies with one or more ASTM standards for liquid resistance or penetration. A liquid resistant material refers to a material that can withstand ASTM 1670 test for liquid penetration, which is a standard test method for resistance of materials used in protective clothing to penetration by synthetic blood. As one of skill in the art will appreciate, many factors can affect the wetting and penetration characteristics of body fluids, such as surface tension, viscosity, and polarity of the fluid, as well as the structure and relative hydrophilicity or hydrophobicity of the materials. The surface tension range for blood and body fluids (excluding saliva) for ASTM 1670 is approximately 0.042 to 0.060 N/m. Suitable examples of a liquid resistant material are known to those of skill in the art and may include one of the Provent or Zytron series from Kappler of Guntersville, Ala. Tychem or Tyvek from DuPont are also suitable for use. A specific embodiment of apparel 10 uses ProVent 10,000 from Kappler. Other liquid resistant shroud materials are suitable for use. A liquid impervious material refers to a material that withstand ASTM 1671 test for liquid penetration, which is a standard test method for resistance of materials used in protective clothing to penetration by blood-borne pathogens using Phi-X174 bacteriophage penetration as a test system. Suitable examples of a liquid impervious material are known to those of skill in the art and may include an of the Zytron series from Kappler of Guntersville, Ala. Tychem or Tyvek from DuPont are also suitable for use.

Body portion 12 includes shroud material 15 and covers at least a portion of the person's torso. For the embodiment shown in FIG. 1, body portion 12 extends perimetrically about the person's torso and downward from the person's shoulders to below the person's groin, thereby shrouding substantially the full torso. In one embodiment, body portion 12 may extend downward from the shoulders to the waist of person 11, or may extend lower than the waist to the knees, the ankles, a point between the thighs and knees, or a point between the knees and ankles. In one embodiment, body portion 12 includes no seams in the front hemisphere to provide a frontal piece that minimizes risk of penetration from an undesirable liquid agent at a seam. As mentioned above, apparel 10 may alternatively resemble a gown where body portion 12 includes an open bottom and apparel 10 includes no pant legs 26.

Hood 20 covers substantially all of the wearer's face, head, and neck except for hole 30 in the back. As shown, hood 20 includes hood shroud material 15 and a viewing window 24. A lower portion of the hood shroud material 15 attaches to an upper portion of body portion 12 at seam 21. Viewing window 24 is configured to rest in front of the person's face when person 11 wears apparel 10. Viewing window 24 allows person 11 to see out of hood 20. Viewing window 24 comprises a thin, lightweight and transparent barrier, such as a suitable plastic. In one embodiment, shroud material 15 included in hood 20 attaches to viewing window 24 about the perimeter of viewing window 24. Shroud material of hood 20 and viewing window 24 may be attached by taping, sewing, or with a suitable adhesive, for example. In one embodiment, shroud material 15 hangs from headgear assembly 80 (FIG. 4B) and viewing window 24 is configured to hang in front of a forward facial section of the face when person 11 wears apparel 10. Viewing window 24 may curve about the person's face to increase unobstructed viewing for person 11.

FIG. 4A illustrates a side elevation view of a headgear assembly 180 worn within hood 20 in accordance with one embodiment of the present invention. FIG. 4B illustrates a top view of headgear assembly 180. Headgear assembly 180 rests upon the head 85 of person 11, lies underneath material of hood 20, and maintains shroud material 15 and viewing window 24 at distant from head 85. Headgear assembly 180 includes a head interface 182 and spacing guards 184.

Head interface 182 comprises a headband 186, support 187 and one or more spacing members 188. Headband 186 circumferentially surrounds head 85 and fits to prevent rotational motion between assembly 180 and head 85. Headband 186 includes an adjustable fastener 189, usually in the back of headband 186, that allows person 11 to change the circumference of headband 186. Support 187 attaches to headband 186 on one side of head 85, extends over the top of head 85 when the person wears headgear 180, and attaches to headband 186 on the other side of head 85. Support 187 provides vertical support to bear the weight of headgear assembly 180, shroud material 15 for hood 20, and viewing window 24. Support 187 includes dual arms having mating and adjustable plastic features that allow the person to adjust fit for the top support 187.

Forward spacing guard 184a and rear spacing guard 184b define the external dimensions of headgear assembly 180. Spacing guards 184 comprise rigid members shaped to contour around the person's head and maintain shroud material 15 distant from the perimeter of head 85. Spacing guards 184 thus largely define an amount of space between the inner surface of shroud material 15 (or viewing window 24) and head 85 for hood 20. Spacing guards 184 attach to shroud material 15 at one or more places on its perimeter. As shown, male ends of a hook and loop fastener 191 are disposed in three places on spacing guards 184 to attach to mating females pieces on shroud material 15 in hood 20 (not shown). Spacing guards 184 thus position and support hood 20 and bear of the weight of shroud material 15 and viewing window 24. Spacing guards 184 also define the vertical cross-section shape of hood 20 (FIG. 4B). Shroud material 15 drops down from spacing guards 184 according to the contour of spacing guards 184.

Spacing members 188 extend down from support 187 and separate spacing guards 184 laterally from head interface 182. Spacing members 188 maintain spacing guards 184 in position relative to head 85 and thus help establish the amount of space between the inner surface of shroud material 15 and head 85 for hood 20. Spacing members 188 each connect a) at their proximate end to head interface 182, and b) at their distal end to a portion of spacing guards 184.

Since shroud material 15 is flaccid and drapes from spacing guards 184, headgear assembly 180 is then configured such that shroud material 15 is spaced above and away from head 85 to provide room for low pressure airflow around head 85. Spacing guards 184 also include a height that extends above head 85 to allow for space between material 15 and head 85 above the top of head 85. Thus, neither spacing guards 184 nor shroud material 15 supported by spacing guards 184 continuously contact head 85 during usage of apparel 10. This arrangement permits low pressure airflow, breathing circulation, and cooling circulation around head 85.

Apparel 10 thus includes a significant internal volume within hood 20. In one embodiment, headgear assembly 180 is dimensioned to roughly maintain an average or minimum distance, D, between shroud material 15 and head 85 (FIG. 4B) absent anything that pushes on shroud material 15. An average or minimum distance from about ½ inch to about 4 inches is suitable in some applications. In another embodiment, headgear assembly 80 is dimensioned such that the inner surface of shroud material 15 is, on average or minimum, from about 1 inch to about 2 inches away from head 85. This creates an internal volume within hood from 2 liters to 10 liters. Headgear assembly 180 preferably comprises lightweight materials so as to minimize encumbrance on person 11. For example, rigid members 92 may comprise a lightweight and stiff plastic. In a specific embodiment, headgear assembly 180 comprises two Willson V5N series headgear browguards assembled to one V5N series head interface. Other headgear and headgear assemblies are suitable for use herein.

Returning back to FIG. 1, left and right sleeves 14a and 14b include shroud material 15 and integrally attach to a shoulder portion of body portion 12 at seams 28a and 28b, respectively. In another embodiment, the entire front portion of apparel 10 is constructed from a single piece of material and seams 28 do not exist between body portion 12 and sleeves 14 as shown. Sleeve 14a is adapted to receive a left arm of person 11 up to the wrist; and left sleeve 14b is adapted to receive a right arm of person 11 up to the wrist. While sleeves 14 are illustrated as extending up to the shoulder of person 11, it is understood that different designs and assemblies if apparel 10 will vary the extent of arm coverage provided by each sleeve 14. At the least, each sleeve 14 receives a portion of an arm, such as forearm to wrist to an upper portion such as from shoulder to elbow. Seams 28 connect the separate pieces of shroud material 15 included in body portion 12 and sleeves 14; and may include stitching, tape, an ultrasonic seal and/or a heat seal, depending on the materials being connected and a desired level of liquid protection.

Gloves 40 are worn at the distal end of each arm. In one embodiment, gloves 40 are disposable, sourced separately, and comprise a liquid impermeable material such as polyethylene, latex, rubber, or the like. The person may tape or otherwise temporarily attach gloves 40 to sleeves 14. Attaching gloves 40 to sleeves 14 allows person 11 to remove apparel 10 as a single unit. In a specific embodiment, apparel 10 is provided with handwear integrally attached to the distal end of sleeves 14 that facilitates removal of gloves 40 worn over the handwear. The handwear is configured such that when a user doffs the handwear and outer glove 40, the handwear restrains the outer glove 40.

Left and right pant legs 26a and 26b include shroud material 15 and each receive a leg of person 11. For apparel 10 shown in FIG. 1, the entire front portion of apparel 10 is made from a single piece of material and seams do not exist between body portion 12 and pants legs 26. In another specific embodiment, pants 26 attach to a lower portion of body portion 12 at seams. As shown in FIG. 1, pant legs 26 extend from body portion 12 just below the hips. In another specific embodiment, the body portion extends lower and the pants 26 extend from the midpoint of the person's thighs. In this case, each pant leg 26 only receives a portion of each leg from the thigh to the foot. As mentioned above, body portion 12 may extend down to a different part of person 11, such as the waist or the knees or below, which will affect the length of pant legs 26.

In the embodiment shown in FIG. 1, pant legs 26 extend and enclose the feet or shoes of person 11. Boots 60 attach to the distal ends of each pant leg 26. Boots 60 cover at least a portion of the feet or shoes worn by person 11 and may include an abrasion resistant material different from shroud material 15. One or more ties, rubber bands or elastics sewn into shroud material 15 may be used to secure excess material included in boots 60. Plastic tape, hook and loop fasteners, male and females snaps, or other detachable binders may also be used other than ties or elastics to secure excess material of boots 60. In another specific embodiment, apparel 10 does not include boots 60.

Shroud material 15 includes one or more relatively thin, flaccid sheets. Shroud material 15 forms a large surface area of apparel 10 and is included in multiple parts of apparel 10 such as body portion 12, sleeves 14, pant legs 26, and hood 20. The number of pieces of material 15 will depend on how apparel 10 is manufactured and assembled, as one skilled in the art will appreciate, and the present invention is not limited to any particular style, assembly, fir, sizing, or design of apparel 10. Usually, a single type of material is employed for shroud material 15 based on a desired application or threat, however, it is contemplated that multiple types of material may be used for shroud material 15 (e.g., one shroud material 15 for body portion 12 and another shroud material 15 for sleeves 14 and/or hood 20). In one embodiment, shroud material 15 comprises a breathable and liquid defensible material selected to reduce or prevent transmission of a targeted undesirable liquid agent through shroud material 15 but to permit minor airflow, such as a suitable non-woven fabric. In another embodiment, shroud material 15 comprises a substantially liquid impermeable material, such as a suitable plastic or non-woven fabric. Shroud material 15 may also comprise a breathable or breathable and splash resistant material, such as a non-woven fabric. Breathable portions of material 15 may also operate as an outlet of air from the environment internal to apparel 10 to the environment external to apparel 10. In addition, different materials may be added or combined to shroud material 15 to increase comfort, protection, strength, appearance, or another property of apparel 10. For example, plastic materials may be combined with non-woven materials to increase protection in the frontal hemisphere or another portion of apparel 10. A commercially available material such as one of the Tyvek or Tychem series as provided by DuPont of Wilmington, Del., is suitable for use in shroud material 15. A non-woven such as one of the Spunbond series as provided by Kimberly-Clark Health Care of Neena, Wis. may also be suitable. In a specific embodiment, one of 7000 or 10,000 as provided by Kappler of Guntersville, Ala., is suitable for use. Shroud material 15 may also comprise a material based on polymers and copolymers of vinyl chloride, vinylidene chloride, ethylene, acrylic acids and esters, methacrylic acids and esters, propylene amines such as polyamides and other polymerizable monomers, cotton and silk, compressed nylon, polyester, and/or spandex (which may be used to increase user comfort and fit).

Seams of the present invention (such as seam 21 between hood 20 and body portion 12) may include sewing, taping, heat sealing, an adhesive and/or solvent or sonic welding. The specific joining technique used will depend on the two materials being joined, cost, manufacturing ease, the desired joint strength, or a desired degree of liquid protection, as one skilled in the art will appreciate. Multiple joining techniques may also be implemented, such as sewing for seal strength and heat-sealing for liquid protection. Other joining techniques may be used.

Other apparel designs are contemplated other than that specifically shown in FIG. 1. For example, apparel 10 need not include a closed hood as shown or may include an open-face hood. Apparel 10 may also include an aperture in the back or front of body portion 12 for donning and doffing. The aperture opens and closes with a zipper, where the zipper may be sealed to shroud material 15 with a flap (not shown) that covers the zipper and adheres to shroud material using plastic tape or one or more mating hook and loop fasteners. In another specific embodiment, apparel 10 includes a transition portal to assist donning and doffing and to reduce the risk of cross-contamination when doffing. The transition portal attaches to the apparel proximate to one end of an aperture, which provides an exit for the protective apparel. When doffing, the transition portal extends away from the person, who exits via the aperture. The transition portal is then pulled over the body along with any attached portions of the protective apparel. This turns the transition portal—and attached parts of the apparel—inside-out. After doffing, most portions of protective apparel are either a) inside-out, or b) contained within the inside-out transition portal and/or apparel. As a result, undesirable liquid agents—that were initially on the outside of the apparel—are now inside the inside-out transition portal and apparel. Further description of a collapsible transition portal that facilitates donning and doffing is described in U.S. Pat. No. 7,748,060 and naming William J. Plut as inventor.

At least one hole 30 permits air to enter and exit apparel 10. As shown in FIG. 1, a single hole 30 is disposed in shroud material 15 in the back of hood 20. This provides inlet air directly to the hood 20 to facilitate breathing of fresh air.

Putting hole 30 in the back hemisphere also reduces exposure to liquid threats that meet the front hemisphere of apparel 10. Other locations for hole 30 are suitable for use. Hole 30 may be disposed in other locations in back of apparel 10, the top of hood 20, on a side of apparel 10, or in lower portions of apparel 10. In a specific embodiment, hole 30 is located in the upper back region of apparel 10 to allow inlet air to proceed towards hood 20. In addition to air for breathing, hole 30 also permits the supply fresh air into apparel 10 for cooling person 11.

Hole 30 is sized and dimensioned to permit low pressure airflow into and out of apparel 10. In one embodiment, hole 30 includes a surface area of at least about 70 square centimeters. In another embodiment, hole 30 includes a surface area of at least about 200 square centimeters. The surface area may be divided amongst multiple holes. Thus, apparel 10 may include multiple holes, such as a second hole 30 disposed on the backside of apparel 10. In this case, airflow into and out of the apparel suitable for respiration and cooling may be divided among the multiple holes, each acting as an inlet and/or exhaust depending on the changing local pressures within apparel 10.

Multiple holes 30 may be arranged to specifically move air along desired paths within apparel 10 or to draw airflow to a certain area within apparel 10. For example, a hole 30 may be located within or near hood 20 to immediately provide air to this area, while one or more outlet holes are disposed at the waist of apparel 10. This arrangement creates a pressure differences between the two holes and about the head and respiratory areas for person 11 to move air across these areas with natural movement of the person, thereby achieving both air for breathing and cooling within a nearly closed garment.

Multiple holes 30 may also be configured to direct air specifically for cooling of person 11. Thus, multiple holes 30 may located on apparel 10 and configured to increase airflow and cooling across the torso, neck and head of person 11, which are generally considered priorities for human thermoregulation. For example, air entering hole 30 in or near hood 20 to increase fresh air supply for breathing may subsequently pass along the body of person 11 for cooling before exhausting from a waist disposed hole.

In one embodiment, apparel 10 is liquid-tight except for communication via one or more holes 30. Apparel 10 then provides a liquid protection garment in which air from the environment external to apparel 10 is transmitted into an environment internal to apparel 10 through hole(s) 30.

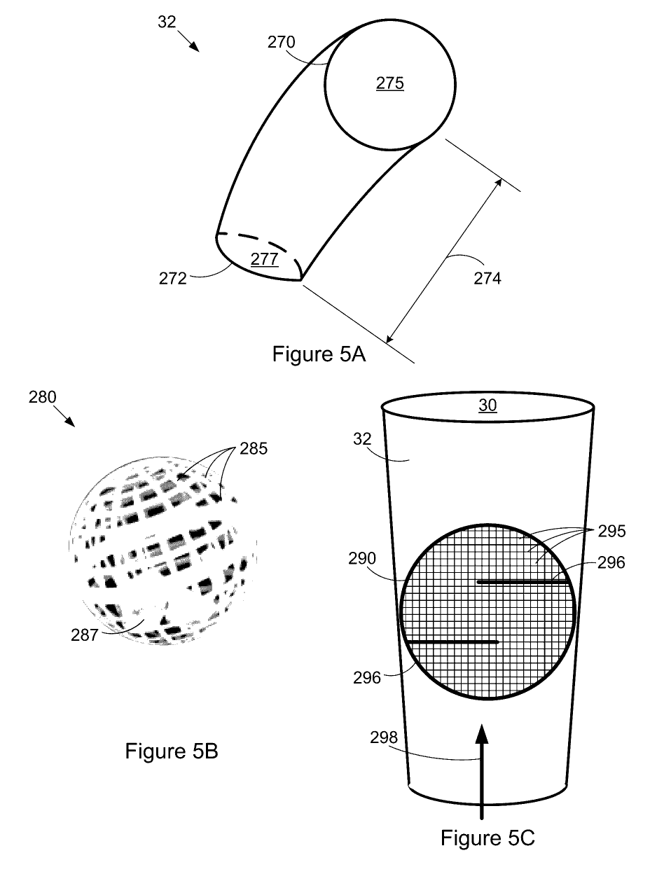

Apparel 10 permits low pressure air movement a) through hole 30 between an internal volume with in the apparel and the external environment, and b) within the shroud material 15. Hole 30 may be extended using an airway tube 32 as described in further detail below with respect to FIGS. 5A-5C.

To enable low pressure air movement within the shroud material 15, improve airflow within the apparel, and/or increase breathing volumes for person 11, apparel 10 comprises a set of spacers that prevent continuous contact between person 11 (and/or garments worn by person 11) and shroud material 15. A set of spacers may be arranged to cooperatively form air channels, within the shroud material 15 of apparel 10, that allow air to move through apparel 10 with relatively little resistance—thus permitting low pressures to move the air.

FIG. 2A illustrates a horizontal cross section of person 11 and apparel 10 taken through a chest region 105 of person 11 wearing apparel 10 in accordance with a specific embodiment of the present invention. FIG. 2B illustrates a horizontal cross section of person 11 and apparel 10 taken through an abdominal region 111 of person 11 wearing apparel 10. FIG. 2C illustrates a front view of spacers 100 attached to an undergarment 107 and worn about the person's torso underneath shroud material 15 in accordance with another embodiment of present invention. FIG. 3 illustrates a top perspective view of a spacer 100 in accordance with a specific embodiment of the present invention.

Referring to FIGS. 2A, 2C, and 3, each spacer 100 is configured to maintain shroud material 15 proximate to the spacer distant from an outer surface and an undergarment 107 and chest region 105 for person 11. Undergarment 107 is worn over chest region 105, may include a vest or t-shirt for example, and will be described in further detail below. In one embodiment, each spacer 100 includes a body 101 having a proximate portion 102 (FIG. 3) that attaches to an outside surface of undergarment 107 and distal portion 104 neighbors and rests against shroud material 15 when person 11 wears apparel 10. In another embodiment, proximate portion 102 attaches to an inner portion of shroud material 15 and distal portion 104 neighbors and rests against chest region 105 when person 11 wears apparel 10. In either instance, spacer 100 keeps shroud material 15 distant from undergarment 107 and person 11 near each spacer. As shown in FIG. 3, each spacer 100 comprises a roughly rectangular block shape. In another specific embodiment, spacer 100 has a truncated right rectangular shape with curved surfaces for distal portion 104 and proximate portion 102. Further description of spacers suitable for use herein is described in U.S. Pat. No. 7,636,955 and naming William J. Plut as inventor, which is incorporated by reference herein for all purposes.

A portion of spacer 100 is referred to herein as proximate when it attaches to a surface such as shroud material 15 or undergarment 107, while a portion is referred as distal when it is arranged away from the attached surface. For spacer 100, proximate portion 102 is a surface, which attaches to undergarment 107 at a location on undergarment 107 such that spacer 100 neighbors a portion of person 11 when the person dons undergarment 107 under apparel 10. In one embodiment, proximate portion 102 attaches to undergarment 107 by taping, sewing, or with a suitable adhesive, for example. Alternatively, proximate portion 102 may include a surface that attaches to shroud material 15 at a location on shroud material 15 such that spacer 100 neighbors a portion of person 11 then they don apparel 10 and shroud material 15.

Neighboring for spacer 100 refers to lying near in position or location. Depending on the size of person 11, fit of apparel 10 or undergarment 107 and the temporary relationship between person 11 and apparel 10, distal portion 104 may be in temporary contact with a portion of person 11 (or clothing 62 worn by person 11), in temporary contact with a portion of shroud material 15, closely situated to either, or relatively removed from either. Often, person 11 wears a clothing layer 60 under apparel 10, such as a T-shirt. The clothing covers one or more portions of the person's body, such as a T-shirt that covers surface 107 of chest region 105. If arranged over a portion of person 11 proximate to a spacer 100 when the spacers attach to shroud material 15, clothing 62 will contact distal portion 104 and not person 11 directly. For sake of discussion, portions of person 11 as described herein neighbored by a spacer include any clothing 62 worn by person 11 when the spacers attach to shroud material 15. In one embodiment, apparel 10 is designed and configured such that each spacer 100 is closely situated or rests in contact with person 11 when person 11 wears apparel 10. The spacers may move. Multiple spacers attached to undergarment 107 will move with undergarment 107. When multiple spacers 100 attach to shroud material 15, which is generally flaccid, it is understood that each spacer 100 and its distal portion 104 may move relative to person 11. For example, shroud material 15 may be pulled away from person 11 as a result of motion by the person or an external force. This may temporarily remove a spacer 100 and distal portion 104 from contact with or close proximity to person 11. The apparel 10 and spacers 100 may then return to their initial position before the disturbance.

As mentioned, apparel 10 includes an undergarment 107 worn under shroud material 15 and the spacers attach to the undergarment. The undergarment 107 may resemble a vest with no sleeves, a short-sleeved shirt, or a long-sleeved shirt, for example, to position spacers about the chest and torso of person 11. Other undergarment designs are suitable for use. The undergarment has a set of spacers attached thereto. In one embodiment, proximate portion 212 or 102 attaches to undergarment 107 by taping, sewing, or with a suitable adhesive, for example. Each spacer in the set a) includes a proximate portion 102 that attaches to a portion of undergarment 107 and a distal portion 104 configured to neighbor an inner portion of shroud material 15 when the person wears the apparel. In another embodiment, undergarment 107 includes a porous material that permits air to pass therethrough and help cool a wearer.

When spacer 100 attaches to undergarment 107, depending on the size of person 11, fit of apparel 10 and the temporary relationship between person 11 and apparel 10, distal portion 104 may be in contact with a portion of shroud material 15, closely situated thereto, or relatively removed therefrom. Since shroud material 15 is generally flaccid and often loose fitting, it is understood that each spacer 100 may contact a different portion of shroud material 15 at different times. For example, shroud material 15 may be pulled away from person 11 as a result of motion by the person (e.g. twisting) or an external force. This may temporarily remove a spacer 100 and distal portion 104 from contact with shroud material 15. The shroud material 15 and spacers 100 may then return to contact at the same or a different location.

In one embodiment, spacer 100 is compliant. The compliance may be achieved with a material having a stiffness suitable to maintain shroud material 15 distant from person 11 while allowing compression of spacer 100 when a threshold force is applied to the spacer. To achieve compliance, body 101 of spacer 100 may comprise a compressible material, such as a compressible foam or sponge. In another embodiment, only a portion of spacer 100 is compliant. For example, a compressible foam or sponge layer may be attached to the surface of distal portion 104 to interface with the body of person 11. Compliance and compressibility of spacer 100 increases comfort for person 11 and reduces forces on person 11 resulting from contact with an external object.

In a specific embodiment, the compliant material has an elastic memory and spacer 100 substantially returns to its initial shape after a deforming force is removed from the spacer 100. A compressible foam with elastic return is suitable in this regard. For example, a closed cell polyethylene foam is suitable for use with compressible spacers 100 in apparel 10. Closed cell polyethylene is available from a wide variety of vendors, many of which offer services to cut large sheets of the foam into desirable dimensions for each spacer 100. The foam may be dimensioned to a desired spacer shape, examples of which are described below. One of skill in the art will appreciate that a wide range of foams and materials offer a suitable stiffness range that allows portions of apparel 10 to maintain a distance from person 11 while providing compliance and elastic return after deforming forces are removed. The packaging industry, for example, relies on numerous foams that are tailored in stiffness for a particular application, such as closed cell polyethylene and polyurethane. A water resistant foam may also be used.

Compliance and elastic return of spacer 100 permits contact between person 11 or apparel 10 and an external object without compromising low pressure airflow within apparel 10 over an extended period of time. This is useful for a health care practitioner wearing the apparel for prolonged periods in a critical care environment in which the practitioner intermittently leans against the operating table or bed or picks up a patient. Alternatively, the compliance and elastic return is useful for individuals working in a clean room such as a semiconductor manufacturing facility where the individuals are required to perform dexterous duties while leaning and coming into contact with solid objects. Further, compliance and elastic return is useful for nurses that frequently perform actions that require large bodily contact, such as assisting an elderly patient using a two arm embrace.

FIG. 2A illustrates a sample set of spacers 120 as arranged circumferentially about a chest region 105 of person 11 when the person wears apparel 10. The set of spacers 120 comprises eight spacers 100a-h: four spacers 100b-e in the front hemisphere of person 11 and four spacers 100a and 100f-h in back. In the absence of a force that compresses any spacer 100a-h, the set of spacers 120 maintains portions of shroud material 15 distant from an outer surface of undergarment 107 and chest 105 for person.

The set of spacers 120 also maintains shroud material 15 between individual spacers 100 distant from the outer surface of undergarment 107 and chest region 105. In one embodiment, the set of spacers 120 is suitably numbered and individual spacers 100 are sized such that, in the absence of a force that compresses any spacer 100a-h or collapses shroud material 15 between spacers 100, the set of spacers 120 prevents shroud material 15 from contacting the outside surface of undergarment 107 and chest region 105 for the entire perimeter of undergarment 107 and chest region 105 (when the person's arms are lifted).

In a specific embodiment, individual spacers 100 in set 120 are positioned at high contour areas around chest region 105 such that a spacing distance, D, between shroud material 15 and chest region 105 is substantially maintained for shroud material 15 around the entire perimeter. It is understood that shroud material 15 is flaccid and may be manipulated by external forces such that portions of shroud material 15 momentarily or intermittently contact the a portion of outer surface of undergarment 107 and chest region 105. Once the forces are removed, shroud material 15 portions between spacers 100 typically return to their position distant from surface 107 of chest region 105.

As a result of the separation distance provided by spacers 100, channels 115 are formed within apparel 10 between individual spacers 100 and between portions of person 11 and inner portions of apparel 10. Channels described herein refer to spaces within apparel 10 that permit the flow of air therethrough. Referring to FIG. 2A, channels 115 are bordered by shroud material 15, outer surface of undergarment 107 and chest region 105, and lateral sides of each spacer 100. For example, channel 115a comprises space within apparel 10 formed between spacer 100a, spacer 100b, shroud material 15 between distal portions of spacer 100a and spacer 100b, and a portion of undergarment 107 between proximate portions spacer 100a and spacer 100b. Similarly, the set of spacers 120 create and maintain eight airflow channels 115a-h arranged circumferentially about chest region 105. Cumulatively, numerous channels 115 inside apparel 10 may store a significant volume of air.

Inner surfaces of shroud material 15 are thus spaced away from undergarment 107 and person 11 to provide multiple airflow channels 115 within shroud material 15. This arrangement permits low pressure airflow and cooling circulation around person 11 with minimal airflow resistance, which facilitates cooling of the person 11 proximate to channels 115, eases the travel of fresh air in apparel 10 for breathing, and eases the movement of air within apparel 10 to and from hole 30. In one embodiment, individual spacers 100 are dimensioned and a set of spacers configured to maintain an average distance, D, between inner portions of shroud material 15 and portions of person 11 (FIG. 2A). An average distance from about ½ inch to about 4 inches is suitable in some applications. In another embodiment, spacers in a set are configured to maintain an average distance from about 1 inch to about 2 inches between the inner surface of shroud material 15 and person 11. Smaller and larger average separation distances are also possible. The separation distance provided by each spacer 100 may vary with where the spacer is located relative to person 11, a desired amount of airflow desired for the portion of person 11 proximate to the spacer 100, and whether the spacer 100 may potentially inhibit movement for person 11. For example, spacers 100 arranged on the outside of a leg may provide a larger separation distance than those arranged on the inside of the leg to minimize any interference on the legs during walking.

FIG. 2B illustrates a sample set of spacers 140 that is arranged circumferentially about an abdominal region 111 of person 11 when the person wears apparel 10. The set of spacers 140 comprises eight spacers 100i-p arranged about abdominal region 111. In the absence of a force that compresses any spacer 100i-p, the set of spacers 140 maintains portions of shroud material 15 proximate each spacer distant from a surface 117 of undergarment 107 around abdominal region 111. The set of spacers 140 also maintains shroud material 15 between individual spacers 100 distant from the surface 117 of undergarment 107 about abdominal region 111. In one embodiment, the set of spacers 140 is suitably numbered and individual spacers 100 are sized such that, in the absence of a force that compresses any spacer 100i-p, the set of spacers 140 prevents shroud material 15 from contacting the outside surface 117 of undergarment 107 about abdominal region 111 for the entire perimeter of abdominal region 111. The set of spacers 140 thus maintain eight airflow channels 115i-p arranged circumferentially about abdominal region 111.

FIG. 3 illustrates a top perspective view of a spacer 100 used in sets 120 and 140. A height 150 and a width 152 are used herein to describe dimensions of spacer 100. Width 152 may be reduced to increase the cross-sectional area of channels 115. Alternatively, when the spacers attach to shroud material 15, width 152 of either proximate portion 102 or distal portion 104 may be enlarged to increase the stability of spacer 100 in maintaining a constant position relative to person 11. Height 150 may also be reduced to increase space for channels and air movement within apparel 10. In one embodiment, spacer 100 has a height from about ¼ inches to about 8 inches. In another embodiment, spacer 100 has a height from about 1 inch to about 4 inches.

Spacer 100 as shown comprises substantially rectangular distal and proximate surfaces 102 and 104, respectively. The simple shape of spacer 100 simplifies manufacture of numerous spacers 100, where any one of the side dimensions for spacer 100, such as height 152, may match the thickness of an off-the-shelf foam sheet. In one embodiment, numerous spacers 100 are manufactured (e.g., cut) from commercially available and inexpensive foam sheets, thereby simplifying manufacture and reducing cost of apparel 10. In a specific embodiment, one side of the sheet comprises a peel adhesive that allows the adhesive to be applied to all the spacers before cutting to further simplify manufacture.

Spacers 100 may also employ other shapes than that shown in FIG. 3. In other embodiments, spacer 100 is shaped to resemble a cylinder, a cone, a cube, a square, a truncated right angle cone body (or frustum), a truncated right pyramid with a square or rectangular base for distal portion 102, a ball-shape, or a hemisphere, etc. Also, while FIGS. 2A and 2B are illustrated with spacers 100 of the same size and shape resembling the rectangular blocks of FIG. 3A or small truncated arcs, it is understood that spacers 100 employed in apparel 10 are not limited to common sizing or shaping.

Cumulatively, the spacers 100 create and maintain an internal volume 190 between the outer garment 15 and a person wearing the apparel 10. This includes lateral channels 115a-p and vertical channels between vertically disposed spacers. More specifically, the set of spacers 120 shown in FIG. 2A and the set of spacers 140 shown in FIG. 2B maintain shroud material 15 vertically between the set of spacers 120 and the set of spacers 140 distant from undergarment 107 and the torso of person 11. Given the relatively small height or volume of individual spacers 100, air channels 115 are then formed vertically between the circumferentially arranged spacer sets 120 and 140. In other words, spacer sets 120 and 140 maintain shroud material 15 away from the torso of person 11 for a majority of the torso, including vertical portions between spacer sets 120 and 140. This permits low pressure air travel around the torso of person 11 within shroud material 15 of apparel 10. Apparel 10 may also include shoulder spacers (such as spacers 100 or other shoulder spacers) that maintain shroud material 15 distant from the shoulders of person 11. Apparel 10 may further include spacers that maintain shroud material 15 distant from the buttocks and thighs of person 11. Cumulatively, the spacers 100 arranged throughout apparel 10 maintain shroud material 15 away from person 11 according to the number, size, and location of spacers employed—and thus create an internal volume within apparel 10.

In addition to improved heat management, the large volume of air within shroud material 15 of apparel 10 facilitates breathing. As will be described in further detail below, shroud material 15 included in hood 20 opens directly into this torso volume of space. In this case, the spacers 100 cumulatively provide an internal volume 190 of air that allows a person to breath without incurring uncomfortable pressure changes internal to shroud material 15 of apparel 10. The internal volume comprises space internal to apparel 10 between the person and inner surfaces of shroud material 15. Since the human respiratory capacity of one breath is generally about 0.5 liters, the large volume of air allows person 11 to take a breath without observing a substantial pressure change within apparel 10, as is common in many conventional protection apparel that do not include a large internal volume of air. Spacer sets 120 and 140 thus facilitate breathing within apparel 10 by reducing pressure fluctuations in the apparel during breathing. One or more spacers 100 may be employed and configured to establish a neck channel that permit low resistance airflow between the inside of hood 20 about the person's face and a buffer volume in body portion 12. Low resistance and low pressure airflow within the channels permits air to be readily moved through the apparel and improves breathing ease by allowing the person to draw air from the buffer volume with negligible effort.

Given the relatively small cross-sectional area or volume of individual spacers 100, spacer sets 120 and 140 thus provide a large internal volume and air within body portion 12 and apparel 10. In other words, when numerous spacers 100 maintain a majority of shroud material 15 away from the torso of person 11, including the shoulders and buttocks, this allows inlet cool air into a large volume internal to apparel 10, thereby providing relatively cool inlet air to cool a large surface of person 11.

Spacers 100 may also combine with biomechanical energy of person 11 to facilitate cooling. More specifically, spacers 100 allow natural movements of person 11 to create pressure disturbances within the internal volume 190 of shroud material 15. The pressure disturbances change air pressure within apparel 10. When the movements of person decrease pressure relative to the ambient air pressure outside apparel 10, then air enters via hole 30. When the movements of person increase pressure within apparel 10 relative to the ambient air pressure, then air exits via hole 30. It is the combination of a) low resistance airflow enabled the by the channels 115 and spacers 100 and b) hole 30 that permit this easy air movement into and out of the apparel 10 using only biomechanical energy of the person.

More specifically, movements of person 11 that decrease pressure in the internal volume 190 relative to the ambient air pressure: move air within shroud material 15, through channels 115, and across the body or clothing (such as undergarment 107) of person 11—thereby cooling person 11. For example, when person 11 lifts an arm, motion of the arm away from a position where person 11 has his arms at his sides creates a local negative pressure disturbance that moves air in from the external environment, into apparel 10, and then within apparel 10 to channel 115e. This local negative pressure in channel 115e draws air into channel 115e, thereby cooling the portion of person 11 in this region. The movement also moves the air within apparel 10 from locations outside apparel 10, bringing fresh and cool air into the suit to cool person 11.

Alternatively, movements of person 11 that increase pressure in the internal volume 190 relative to the ambient air pressure: move air within shroud material 15, through channels 115, and across the body or clothing (such as undergarment 107) of person 11—thereby cooling person 11—and out through hole 30. For example, when person 11 returns his right arm to his side such that channel 115e collapses, this creates a local positive pressure that pushes air out of channel 115e, thereby moving air into other portions and channels 115 of apparel 10 affected by the local pressure increase, and potentially some of that air escapes out of apparel 10 through hole 30.

In general, any movements of person 11 and/or shroud material 15 may cause local disturbances move air in or out of the internal volume 190 in apparel 10 to cool of person 11. Indeed, an advantage of the present invention is that natural motions by the torso of person 11 may lead to air movement within internal volume 190, such as those associated with walking and twisting. Since the muscles of person 11 that move a person's torso are relatively large, this allows a passive form of air distribution and cooling within apparel 10 that requires minimal added effort from person 11. For example, walking may lead to considerable air movement and circulation within apparel 10, thereby passively cooling person 11.

Typically, the biomechanical energy and associated movements change dimensions internal to apparel 10 and thus changes local internal pressures within a portion of internal volume 190 relative to the ambient pressure outside apparel 10. So, a movement that causes a decrease in internal pressure within the apparel draws air from the external environment through hole 30 into apparel 10, while another movement that causes an increase in internal pressure within a portion of internal volume 190 relative to the ambient pressure pushes air from within the apparel through hole 30 and into the external environment.

The changes in air pressure within apparel 10 can be local or very large. For example, some movements like bending over will increase air pressure in large amounts of internal volume 190 and push considerable air out through the hole 30. Other movements such as moving a single arm might only cause a local air pressure drop that pulls a smaller about of air inwards.

The biomechanical energy can be passive or active. Active biomechanical energy occurs when the person intentionally uses body movements to actively pump air in and out. For example, with complaint spacers 100, a person may compress multiple spacers in the chest area using their arms (by hugging themselves quickly) in order to change the air pressure internal to apparel 10. The decreased volume will include the compressible spacers and any air channels maintained by the spacers. This moves air out of the suit with each volume decrease and pressure increase. Air enters back into the apparel 10 when the compressible spacers regain their shape, which returns each spacer volume and recreates the air channels, and creates a negative pressure in the suit that draws air in through hole 30. A person may move several liters of air through hole 30 with each compression. Multiple compressions using the arms circulate a significant amount air for cooling and/or breathing.

Passive biomechanical energy occurs from movements that a wearer makes when wearing the suit that are not intended to move air into and/or out of apparel 10. These passive biomechanical movements typically arise while wearing the apparel for an intended purpose. Examples include walking, torso bending or twisting, lifting and moving arms, turning a head, etc. in the course of activities taken while wearing apparel 10 for its intended purpose. So a nurse working in an infectious disease ward will make various movements in the course of treating patients such as bending to lift a patient, walking between patients, moving arms to provide treatment, etc. Each of these passive biomechanical movements may change internal pressure within apparel 10 and move air in and/or out. Typically, apparel 10 circulates more air with greater movement of its wearer, whether passive or active.

Local pressure disturbances that draw air in through hole 30, or push it out, are not limited to movement of person 11 and may be the result of disturbances to shroud material 15. For example, someone may bump into the wearer and compress one or more spacers 100 or air channels 115. Thus, external forces that move shroud material 15 around channel 115e may also move air in and out of hole 30 for passive cooling of person 11.

A set of spacers 100 as described herein includes any number of spacers configured to maintain shroud material proximate to the spacers distant from one or more portions of person 11. In one embodiment, apparel 10 comprises from 1 spacer to about 200 spacers. In a specific embodiment, apparel 10 comprises numerous small spacers—over 100, each of about an inch or less. In another specific embodiment, apparel 10 comprises from about 15 spacers to about 30 spacers with a 2 inch height 150.

A set of spacers may be locally defined and established for particular portions of person 11, such as sets 120 and 140 described above for chest region 105 and abdominal region 111, respectively. Spacers and spacers sets may also be arranged proximate to other portions of person 11 to maintain apparel proximate to the spacer and spacer set distant from a portion of the person, such as a buttocks portion, leg portions such as the thighs, knees and calves, a head or a neck portion, and arm portions such as the upper arm, elbows and forearms, etc. In a specific embodiment, a set of spacers is arranged circumferentially about a buttocks region of person 11 when the person wears apparel 10, similar to the arrangement shown in FIG. 2B. Generally, spacers 100 may be arranged anywhere such that they neighbor a desired portion of person 11 to maintain apparel proximate to the spacers distant from the portion of person 11, to create channels and increase internal volume 190. Portions of person 11 with high curvature where shroud material 15 would normally be expected to come in contact with person 11 are well suited. In one embodiment, a set of spacers is arranged to neighbor a high contour portion (shoulders, buttocks, outside portions of arms and legs, etc.) of person 11 such that the spacing distance, D, between shroud material 15 and portion of person 11 is substantially maintained for shroud material 15 around the high contour portion. Thus, in the absence of a force that compresses the spacers, the set of spacers 120 prevents shroud material 15 from contacting the high contour portion. In another embodiment, the number and density of spacers increases when neighboring a high contour portion of person 11.

For example, shoulder spacers 100 may be arranged proximate to each shoulder to maintain shroud material 15 from the shoulders of person 11. This may include spacers 100 on the back of shoulders for person 11, over the top of the shoulders, to the front of the shoulders. If a set of spacers is arranged in the chest region, such as set 120 described with respect to FIG. 2A, the set of spacers 100 cumulatively maintains shroud material 15 away from an upper chest and shoulders of person 11. Air channels 115 are formed between each shoulder spacer 100, and between any spacers 100 in the chest region (FIGS. 2A and 2C). This creates a large internal volume 190 with low pressure air flow from the chest region to hole 30, and out to the ambient environment.

Referring to FIG. 2C, undergarment 107 is donned like a vest or t-shirt before shroud material 15 is put on. In this case, individual spacers 100 are positioned on undergarment 107 around the shoulders 180 and chest 120 such that shroud material 15 is substantially maintained above the surface of undergarment 107 near the shoulders 180 and chest 120. It is understood that shroud material 15 is compliant and may be manipulated by external forces such that portions of shroud material 15 momentarily or intermittently contact the surface of the shoulders 180 and chest 120. In general however, as a result of the separation distance provided by spacers 100, channels 115 are formed within apparel 10 between individual spacers 100 about the shoulders 180 and chest 120 of person 11 and inner portions of shroud material 15.

The set of spacers within apparel 10—such as those described in sets 120, 140 and those about the shoulders 180—then provide a large network of low resistance airflow channels within shroud material 15. Biomechanical energy and movements of the person 11 or shroud material 15 then move air from the external environment (which is typically cooler), into through hole 30, and through a large network of low resistance channels 115. This low pressure easy supply of fresh inlet air across a large surface of person 11 eases heat management for the person. In one embodiment, shroud material 15 in the lower region of hood 20 opens directly into the internal volume 190 and channels 115 provided by spacers in the shoulder 180 and chest region 105 of person 11. Air movement into and out of hole 30 arranged in the top of hood 20 creates a low pressure airflow system. This results in continuous airflow in and out of hole 30, over portions of the waist, over portions of the chest, over portions of the shoulders, over portions of the neck, over the face and head of person 11, as long as the person keeps moving.

Apparel 10 permits low pressure airflow both a) within the apparel and b) into and out of the apparel. As the term is used herein, ‘low pressure’ airflow refers to movement of air caused by pressure differences less than about 6 millimeters of water. In a specific embodiment, ‘low pressure’ airflow less than about 2.5 millimeters of water. Thus, a movement by person 11 that creates a pressure difference that is less than about 6 millimeters of water lower than the ambient air pressure is enough to draw air into the apparel through hole 30 and move the air within the channels 115 of apparel 10. Similarly, biomechanical energy of person 11 that creates a pressure difference that is less than about 6 millimeters of water greater than the ambient air pressure is enough to move the air within the channels 115 and push the air out from the apparel through hole 30.

Protective apparel of the present invention finds wide use in shielding a wearer from an undesirable liquid or droplet agent. Generally, the present invention finds use in any environment where a person wears protective clothing to defend from an undesirable liquid or droplet agent. Undesirable liquid or droplet agents may include liquid agents, biological and/or chemical molecules in a liquid solution such as water, microorganisms in water or saliva, droplets, and other non-gaseous substances that the person wants minimal or zero exposure to. Thus, health-care practitioners working in environments where liquid or droplet biological agents are probable may benefit from wearing apparel described herein. Apparel 10 is well suited to defend against threats related to SARS, ebola, anthrax, and other liquid or droplet based threats. Apparel 10 is also well suited for use in other environments such as those associated with chemical and industrial environments where direct liquid contamination is to be minimized or avoided.

Protective apparel as described herein is also well suited for prolonged usage. Nurses commonly wear protective apparel for hours at a time, and thus may benefit from the present invention. There are numerous other applications in which a health-care practitioner or another individual benefits from protective apparel that is used to shield the person from a biological or chemical agent. For example, health care practitioners treating individuals that generate a liquid biological agent, such as Ebola, may benefit from the full coverage protective apparel described herein. Alternatively, surgeons and other surgical staff in an operating room may rely on defense provided by protective apparel described herein against a liquid agent during surgery.

Apparel 10 is also well suited for use in low contamination rooms and other places such as “clean rooms”. The latter is common in the semiconductor industry where contamination contributions by occupants are to be reduced.

As described herein, an internal volume 190 refers to a contiguous air space substantially maintained within shroud material 15 of apparel 10 during usage by person 11. In one embodiment, the internal volume 190 within shroud material 15 mainly comprises space within the apparel created by spacers 100, such as the sum of the volume in connected channels 115. Sample areas within apparel 10 that may contribute to the internal volume include spaces between the shroud material 15 and the person's torso, shoulders, arms legs, any space within hood 20, and combinations thereof. In one embodiment, the internal volume 190 within apparel 10 includes a volume of at least about four liters. In another embodiment, spacers 100 and channels 115 create an internal volume 190 within apparel 10 of at least about seven liters. In an even more spacious embodiment, the internal volume 190 within apparel 10 includes a volume of at least about ten liters. The internal volume 190 may also vary with the fit of apparel 10 and the size of person 11.

Channels 115 within apparel 10 may be linked to provide a large internal volume 190. In the absence of a force that compresses any spacer 100, the spacers 100 maintain channels 115 and internal volume 190, as well as maintain low pressure airflow communication within the internal volume. When internal volume 190 doubly opens into hole 30 and into the hood 20, this provides low resistance airflow to the mouth and nose of person 11 from the external environment, and the internal volume 190 allows person 11 to inhale and exhale without incurring uncomfortable pressure changes.

Apparel 10 also includes one or more elements to reduce fluid flow through hole 30. FIG. 5A shows an elevated perspective view of a protected airway tube 32 (shown separate from apparel 10) in accordance with a specific embodiment of the present invention. FIG. 1 shows tube 32 extending from shroud material 15 at hole 30. Tube 32 attaches to shroud material 15 about the perimeter hole 30 and provides defense against undesirable liquids readily moving in through hole 30 while permitting easy air flow through tube 32 and hole 30. Tube 32 includes shroud material 15 and attaches to shroud material 15 at hole 30 by sewing, taping, adhesive, etc.

Protected airway tube 32 reduces the likelihood of liquids entering hole 30. In this instance, since tube 32 hangs down from hole 30, for a liquid to get into hole 30, the liquid must travel up through tube 32 (defying gravity) and then turn orthogonally into the hood 20.

Tube 32 includes a proximate end 270 that attaches to shroud material 15 about the perimeter of hole 30 and a distal end 272 that opens to the surrounding environment. Tube 32 also includes length 274 between proximate end 270 and distal end 272.

In one embodiment, tube 32 the cross sectional area of proximate end 270 is approximately the same as the diameter of distal end 272, and the cross sectional area of tube 32 remains consistent along length 274. In this instance, and when tube 32 is relatively circular along length 274, then tube 32 resembles a cylinder. As shown in FIG. 5A, tube 32 includes a frustoconical shape where the cross sectional area changes along length 274. As shown, tube 32 includes a larger opening 275 at proximate end 270 where it opens to hole 30 than the opening 277 at distal end 272, thus giving tube 32 a frustoconical shape that reduces in cross sectional area as it approaches distal end 272.

It should also be noted that the cross sectional geometry of opening 275 and opening 277 are not limited to circles. For example, proximate end 270 where tube 32 attaches to hood 20 may also include an elliptical shape where the horizontal width of an ellipse opening 275 is larger than its vertical dimension. This is well suited for use when the vertical space in hood 20 does not permit a large enough vertical hole and the horizontal dimension increases to permit a larger hole 30 surface area. Other cross sectional shapes and dimensions are suitable for use with opening 275 and opening 277. It is also noted that the flaccid material in shroud material 15 and tube 32 may change according to external forces and design or fit of apparel 10 so the cross sectional geometry of tube 32 may not always be perfectly circular or elliptical when in use.

The cross sectional area of proximate end 270 and distal end 272 are large enough to permit low pressure airflow into and out of apparel 10. In a specific embodiment, proximate end 270 has a cross sectional area between about 77 square centimeters and about 160 square centimeters. A cross sectional area between about 60 square centimeters and about 160 square centimeters is suitable for use with distal end 272. The cross sectional areas may be increased to permit greater airflow for cooling purposes, and may also vary with the size of apparel 10, hood 20, or where tube 32 attaches onto apparel 10.

When a flaccid material is used in tube 32, then external forces are capable of reducing the cross sectional area of the tube in one or more spots along its length. Tube 32 may thus include one or more supports to maintain cross sectional area opening. For example, each end 270 or 272 may include a semi-rigid or rigid collar to help maintain its cross sectional area open. In this case, a metal wire or semi-rigid plastic strip may be sewn into a seam or hem at either end 270 or 272 to help keep the flaccid material in shroud material 15 of tube 32 from collapsing. Other items suitable for use to maintain the cross sectional area of ends 270 or 272 include rigid tape along the circumference, plastic wires, a porous ball (FIG. 5B-5C), etc.

Length 274 should be long enough to deter liquid entry through hole 30. In a specific embodiment, length 274 is between about 8 centimeters and about 50 centimeters. In a specific embodiment, a length 274 of at least 30 centimeters is suitable for use. Other lengths are suitable for use based on one or more of: the location of hole 30 on apparel 10, the cross sectional areas of proximate end 270 and distal end 272, and configuration of apparel 10.

Although tube 32 is shown with a relatively straight line for the center of the tube along length 274, it may also curve to help reduce liquid travel through hole 30. For example, adding more shroud material to the top side of tube 32 gives a downward arc to the tube and helps the distal end 272 point downward. The cross sectional area of proximate end 270 and/or distal end 272 may also be decreased to reduce the ability of an undesirable fluid agent from entering apparel 10 through hole 30.

In another embodiment, tube 32 includes a liquid obstruction configured to disturb flow of a liquid through the tube. FIG. 5B shows a liquid obstruction 280 for use in tube 32 in accordance with a specific embodiment. FIG. 5C shows another liquid obstruction 290 placed in in tube 32 in accordance with another specific embodiment.

Liquid obstruction 280 intercepts air and liquids in tube 32 before flow into hole 30 and reduces the likelihood of an undesirable liquid from entering apparel 10. Liquid obstruction 280 resembles a ball that rests in tube 32. The ball may be held in tube 32 using hook and look fastener or another mechanism for detachable attachment if ball is meant for re-use. Otherwise, if ball 280 is disposable, it may be attached to tube 32 in a desired location. In a specific reusable embodiment, the diameter of ball 280 is selected such that the ball rests in tube 32 between proximate end 270 and distal end 272 based on size and fit between the ball 280 diameter and tube 32 diameter. For example, for a frustoconical tube 32 whose proximate end 270 diameter is X and whose distal end 272 diameter is Z, then the diameter of ball 280 is Y such that X>Y>Z. This permits the ball to be readily placed into tube 32 through proximate end 270, and fall into the tube until the decreasing diameter of tube 32 stops it. A little push on the ball 280 may also stretch the shroud material 15 in tube 32 and provide a tensile hold that keeps the ball in place despite disturbances or turning the tube upside down.

Liquid obstruction 280 is sized and selected to disturb liquid flow through it, but is porous enough to allow air to pass therethrough with minimal air resistance and to permit low pressure airflow into and out of apparel 10. In this case, ball 280 includes bars 285 on its surface area. The bars 285 collectively form a surface area pattern and enough surface area to distrub liquid flowing from one side of the ball to the other, but permits air to pass therethrough with minimal air resistance. Since the ball spans the cross sectional are of tube 32, any liquid passing through tube 32 is subject to disruption by ball 280 and its arms 285. One ball suitable for use in this regard is the 2012 ZX New Bio Filtration media (Porous double floating ball) available from Alibaba at Alibaba.com.

A second liquid obstruction 287 may also be disposed in ball 280. The second liquid obstruction 287 deters liquid passage through ball 280. Suitable obstructions 287 include a smaller ball made from a foam or another material and disposed in ball 280, a sponge disposed in ball 280, pellets suitable sized to stay in ball 280 and impede liquid flow, etc.

Other liquid filters are suitable for use. As one of skill in the art will appreciate, the filtration industry provides a large number of water filters for insertion into a flow to filter particles from the water. Such filters are intended to impede fluid flow with minimal liquid pressure drop and are thus useful to provide minimal air pressure flow resistance. Such filters are useful in apparel 10 to disrupt the flow of liquids into the apparel, particularly when tube 32 forces an entering liquid to overcome gravity. Several suitable porous floating balls are available at Alibaba.com.

FIG. 5B shows a custom ball 290 specifically designed for use in tube 32. Ball 290 includes an outer surface area with bars 295 intermittently disposed on the spherical surface to disrupt fluid flow through ball 290, similar to ball 280.

Ball 290 also includes one or more flanges 296 that further obstruct and deter liquid flow through tube 32. Each flange resembles a roughly flat and thin semi-circle at the vertical position shown in FIG. 5B that blocks at least half of the cross sectional area of tube 32 in the vertical direction. As shown, each flange 296 extends slightly past the half way vertical midpoint. Looking from the bottom of ball 290 or tube 32, these two flanges block the entire cross sectional area of ball 290 and tube 32. Multiple flanges offset from each other increase the resistance to easy fluid travel. As shown, flanges 296 force liquid 298 attempting to travel through ball 290 and tube 32 to navigate multiple right turns to get to hole 30. When tube 32 is disposed on apparel 10 as shown in FIG. 1 and gravity pulls on any liquid 298 moving upward to hole 30, flanges 296 reduce fluid travel into hole 30 since gravity will pull any liquid down after flow interruption by a flange 296. However, ball 290 and flanges 296 do not significantly add to air flow resistance, and thereby permit low pressure airflow into apparel 10 while significantly disturbing fluid flow.

Other structures are suitable use in tube 32 to obstruct liquids attempting to pass into hole 30. In another specific embodiment, a porous cylinder is designed and configured for insertion into tube 32. The porous cylinder has a height slightly smaller than length 274 and a diameter that is only slightly less than the tube 32 diameter. This maintains the tube 32 open along the length of the porous cylinder. The porous cylinder may include any surface area or volumetric liquid flow obstructions that deter liquid passage to hole 30.

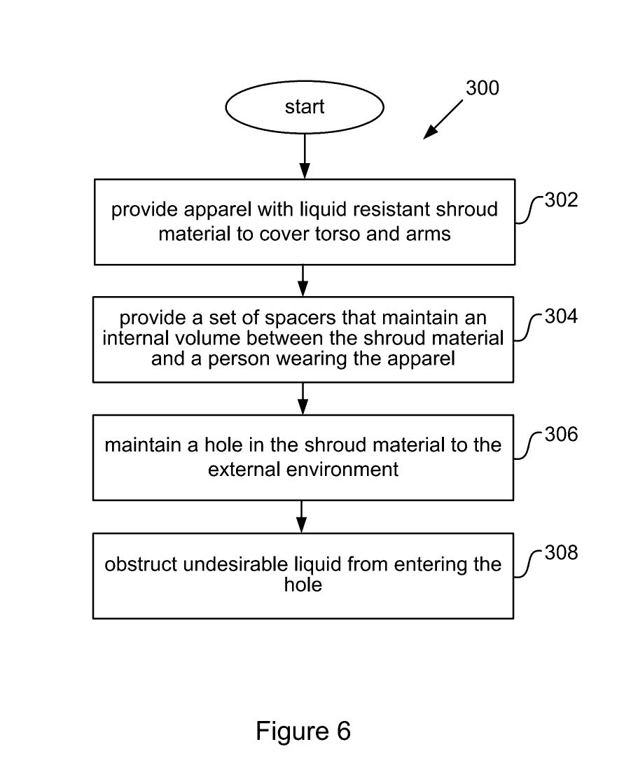

FIG. 6 illustrates a method 300 for protecting a person from an undesirable liquid agent in accordance with one embodiment of the invention. Method 300 begins by providing a liquid resistant shroud material including a body portion and sleeves to cover the torso and arms respectively (302). Apparel 10 of FIG. 1 is one such suitable full body suit. Apparel with less than full body coverage is also suitable for use. For example, apparel that does not include pants is also suitable for use; separate pants may be worn if desired.

Method 300 continues by providing a set of spacers that maintain an internal volume between the liquid resistant shroud material and a person wearing the apparel (304). Numerous spacers within apparel 10—such as those described in sets 120 and 140—provide an internal volume comprising numerous low resistance airflow channels within body portion 12 and other internal portions apparel 10. One or more spacers 100 configured to neighbor a neck of the person creates a neck air channel for apparel 10 between the body portion and hood where the hole rests. This permits easy low resistance movement between the internal volume in body portion 12 into and out of hood 20.

Method 300 maintains a hole in the liquid resistant shroud material to the external environment (306). The hole permits low pressure air movement between the internal volume and an external environment outside the liquid resistant shroud material. Coupled with biomechanical energy of the person, this low pressure air movement supplies fresh air into the internal volume, including the upper body, head and neck, which facilitates breathing and cooling for the wearer.

The undesirable liquid agent is then obstructed from entering the hole so that it is not free to move through the hole and into the apparel from the external environment (308). This uses one or more mechanical liquid obstructions configured to disturb flow of a liquid through the hole. Apparel 10 includes tube 32 and optionally a ball as shown in FIG. 5B or 5C.

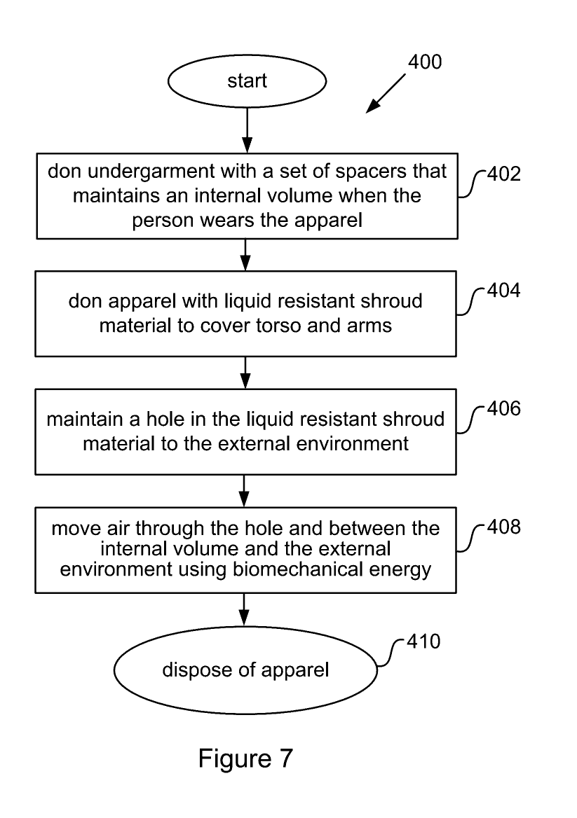

FIG. 7 illustrates a method 400 for using protective apparel in accordance with another embodiment of the invention. Method 400 begins by donning an undergarment with a set of spacers that is configured to maintain an internal volume when the person wears the apparel (402). The undergarment may be a vest worn under the shroud material or another layer of the protective apparel worn under the shroud material. It includes a set of attached spacers, such as a compressible foam. The compressible material reduces forces on the person resulting from contact with an external object. When the compressible material has an elastic memory, elastic return of the compressible material causes each spacer to return to its initial shape after a deforming force is removed. The elastic return thus permits contact between the person or apparel and an external object without compromising low pressure air flow over an extended period of time.

Method 400 then includes donning a liquid resistant shroud material including a body portion and sleeves to cover the arms (404). Apparel 10 of FIG. 1 is one such suitable full body suit. Apparel with less than full body coverage is also suitable for use.

The apparel maintains a hole in the liquid resistant shroud material to the external environment (406). The hole permits low pressure air movement between the internal volume and an external environment outside the liquid resistant shroud material. The hole may simply be maintained by how the apparel rests when worn by the person. More active techniques can be used to keep the hole open, such as adding a plastic band, guard, or tape about the perimeter of the hole.

Biomechanical energy of the person wearing the apparel then moves air through the hole and between the internal volume and the external environment (408). More specifically, the biomechanical energy creates pressure differences within the apparel, which are sometimes temporarily greater than the ambient environment or sometimes temporarily less than the ambient environment. A temporarily lower relative pressure air movement within the apparel draws in and supplies fresh air into the internal volume, including the upper body, head and neck, which facilitates breathing and cooling the wearer. A temporarily higher relative pressure air movement within the apparel exhausts air from the apparel.

The biomechanical energy can be active or passive. A passive biomechanical energy movement occurs when the person takes an action that is not intended to move air in or out. For example, an inhalation may often be enough to draw air into the apparel. This may include a partial inhalation or deep breath.

An active movement occurs when the person wants to cool themselves and makes intentional motions that move air in and out. For example, folding the arms and pushing them against multiple compressible chest spacers pumps a large volume of air out of the apparel. This happens for two reasons: first, the pressure internal to the apparel increases from the arm force on the shroud material and spacers, and second since both the compressible spacers and their respective air channels collapse under the arms then this decreases the available internal volume which also pushes air out. Removing the arms has the opposite effect. Elastic recoil of the compressible spacers reforms the air channels and then creates a negative pressure that draws fresh air into the apparel. This arm ventilation can be repeated a few times to actively refresh most of the air within the apparel in seconds.

As long as the person keeps moving, pressure changes from biomechanical energy result in continuous net airflow into the hood, into body portion 120 and eventually out of the hole. This enables the apparel to not need a fan to move air into the internal volume from the external environment. The air provided by via the hole and biomechanical energy ventilates the environment internal to apparel, cools the person wearing apparel and provides fresh air for breathing. As one of skill in the art will appreciate, the inlet airflow rate will vary with the amount of movement of the person wearing the apparel. In one embodiment, the apparel permits an air flow rate of at least about 5 cubic feet per minute through the hole using biomechanical energy movements over the course of the minute. In another specific embodiment, the apparel permits an air flow rate of at least about 15 cubic feet per minute through the hole using biomechanical energy.

In one embodiment, apparel 10 is disposable (408). In some cases, all portions of apparel 10 are disposable except the undergarment 107, headgear assembly, and/or the liquid ball 280 or 290 in tube 32, which are intended for re-use. These parts may be separated before disposal. Disposable apparel benefits health care environments and hospitals since practitioners may rid of contaminated materials readily.

Although the foregoing invention has been described in some detail for purposes of clarity of understanding, those skilled in the art will recognize that various modifications may be made within the scope of the appended claims. For example, although the present invention has been described with respect to a garment assembly that provides full body coverage, one of skill in the art will appreciate that advantages of the present invention may be realized in a suit that covers less than the entire body. In addition, although the present invention has primarily been described with respect to compressible and compliant spacers 100, other spacers may be used. The invention is, therefore, not limited to the specific features and embodiments described herein and claimed in any of its forms or modifications within the scope of the appended claims.

What is claimed is:

1. Apparel for protecting a person from an undesirable liquid agent, the apparel comprising:
a liquid resistant shroud material employed in a body portion configured to cover at least a portion of a torso of the person when the person wears the apparel, a first sleeve configured to receive a portion of a right arm of the person, and a second sleeve configured to receive a portion of a left arm of the person;
a set of internal spacers, where each spacer is configured to maintain shroud material proximate to the spacer distant from the person, and the set of spacers is configured to create and maintain an internal volume between the liquid resistant shroud material and a person wearing the apparel; and
at least one hole in the liquid resistant shroud material that includes a surface area of at least about 70 square centimeters and is configured to permit air movement between the internal volume and an external environment.

2. The apparel of claim 1 wherein the apparel permits low pressure air movement through the at least one hole between the internal volume and an external environment for a pressure difference between the internal volume and the external environment of less than about 6 millimeters of water.

3. The apparel of claim 1 wherein the protective apparel is configured such that pressure in the internal volume is substantially the same as the external environment and wherein passive biomechanical energy from the person is sufficient to exhaust air from the internal volume into the external environment through the at least one hole.

4. The apparel of claim 1 wherein the apparel is configured to create and maintain an internal volume of at least seven liters when the person wears the apparel.

5. The apparel of claim 1 wherein the at least one hole includes a surface area of at least about 200 square centimeters.

6. The apparel of claim 1 wherein the apparel further comprises a tube that extends from the shroud material at the at least one hole.

7. The apparel of claim 6 wherein the tube includes a liquid obstruction configured to disturb flow of a liquid through the tube.

8. The apparel of claim 6 wherein the tube is at least 30 centimeters in length.

9. The apparel of claim 1 wherein the spacers are attached to an undergarment configured to be worn by the person under the outer garment.

10. The apparel of claim 1 wherein the at least one hole does not include an air filter and wherein the protective apparel does not use a fan to move air into the internal volume from the external environment.

11. The apparel of claim 1 further comprising a hood attached to shroud material included in the body portion and including a viewing window is configured to rest in front of the person's face when person wears the apparel.

12. A method of protecting a person from an undesirable liquid agent, the method comprising:
providing a liquid resistant shroud material including a body portion configured to cover at least a portion of a torso of the person when the person wears the apparel, a first sleeve configured to receive a portion of a right arm of the person, and a second sleeve configured to receive a portion of a left arm of the person;
providing a set of spacers configured to maintain an internal volume between the liquid resistant shroud material and a person wearing the apparel;
maintaining at least one hole in the liquid resistant shroud material, where the at least one hole includes a surface area of at least about 70 square centimeters and is configured to permit air movement between the internal volume and an external environment; and
obstructing the undesirable liquid agent from entering the at least one hole from the external environment.

13. The method of claim 12 further comprising permitting low pressure air movement through the at least one hole between the internal volume and an external environment for a pressure difference between the internal volume and the external environment of less than about 6 millimeters of water

14. The method of claim 12 wherein obstructing the undesirable liquid agent from entering the at least one hole includes adding a tube to the apparel that extends from the liquid resistant shroud material at the at least one hole and adding a liquid flow obstruction in the tube that is configured to disturb flow of a liquid through the tube.

15. The method of claim 12 wherein the protective apparel is configured to not use a fan to move air into the internal volume from the external environment.

16. A method of using protective apparel worn by a person, the method comprising:
donning an undergarment including a set of spacers;
donning a liquid resistant shroud material including a) a body portion configured to cover at least a portion of a torso of the person when the person wears the apparel, b) a first sleeve configured to receive a portion of a right arm of the person, and c) a second sleeve configured to receive a portion of a left arm of the person, and d) at least one hole that is configured to permit air movement between the internal volume and the external environment outside the outer garment;
wherein the set of spacers is configured to maintain an internal volume when the person wears the apparel; and
using biomechanical energy of the person wearing the apparel to move air through the at least one hole and between the internal volume and the external environment.

17. The method of claim 16 wherein the biomechanical energy provides low pressure air movement through the at least one hole between the internal volume and an external environment using a pressure difference between the internal volume and the external environment of less than about 6 millimeters of water.

18. The method of claim 17 wherein the mechanical energy moves at least 15 cubic feet per minute of air through the at least one hole.

19. The method of claim 16 wherein the biomechanical energy comes from a passive movement of the person that occurs when the person takes an action that is not intended to move air in or out.

20. The method of claim 16 further including reducing the ability of the undesirable liquid agent from moving into the at least one hole by adding a tube to the apparel that extends from the liquid resistant shroud material at the at least one hole and by adding adding a liquid flow obstruction in the tube.
